(19) United States
(12) Patent Application Publication
(10) Pub. No.: US 2026/0067356 A1
(43) Pub. Date: Mar. 5, 2026

(54) DISTRIBUTED GPU INSTRUCTIONS PROCESSING WITH NETWORK LATENCY OPTIMIZATION

(71) Applicant: Thunder GPU, Inc., Atlanta, GA (US)

(72) Inventors: Brian Model, Atlanta, GA (US); Carl Peterson, Atlanta, GA (US)

(21) Appl. No.: 19/285,535

(22) Filed: Jul. 30, 2025

Related U.S. Application Data
(60) Provisional application No. 63/691,191, filed on Sep. 5, 2024.

(51) Int. Cl. G06F 9/50

(52) U.S. Cl. CPC H04L 67/1012; G06F 9/5072; H04L 41/045; G06F 2209/503

(57) ABSTRACT

Methods, systems, and apparatus, including computer programs encoded on computer storage media for distributed GPU instructions processing with network latency optimization. A manager service receives, from a client device, a request to use one or more GPUs for performing GPU operations. The request is made from a customized Accelerator API executed on the client device. The manager service transmits to the client device an IP address for access to a GPU server. The GPU server receives from the client device over a wide-area network (such as the Internet), a plurality of GPU instructions to be performed. Using local Accelerator API functions to perform the GPU instructions on a local GPU installed on the GPU server, the GPU server performs the GPU instructions. The GPU server receives from the local GPU output results and/or error codes based on the processing of the GPU instructions by the local GPU.

### CROSS-REFERENCE TO RELATED APPLICATIONS

This application claims the benefit of priority to U.S. Provisional Application No. 63/691,191, filed on Sep. 5, 2024, which is hereby incorporated by reference in its entirety.

### FIELD

This patent application relates generally to GPU instruction processing, and more particularly, remote distributed GPU instructions processing and network latency optimizations via a customized Accelerator API.

### SUMMARY

In some embodiments, methods, systems, and apparatus, including computer programs encoded on computer storage media are provided for distributed GPU instructions processing with network latency optimization. A manager service receives, from a client device, a request to use one or more GPUs for performing GPU operations. The request is made from a customized Accelerator API executed on the client device. The manager service transmits to the client device an IP address for access to a GPU server. The GPU server receives from the client device over a wide-area network (such as the Internet), a plurality of GPU instructions to be performed. Using local Accelerator API functions to perform the GPU instructions on a local GPU installed on the GPU server, the GPU server performs the GPU instructions. The GPU server receives from the local GPU output results and/or error codes based on the processing of the GPU instructions by the local GPU. The GPU server transmits to the client device the output results and/or error codes to the client device. In some modes of operation, the customized Accelerator API performs network optimization functions such that one or more GPU instructions are not sent to the GPU server, but instead results for the GPU instructions are returned to an application, software or service that made the API calls to the customized Accelerator API.

The appended claims may serve as a summary of this application.

### BRIEF DESCRIPTION OF THE DRAWINGS

FIG. 1A is a diagram illustrating an exemplary environment in which some embodiments may operate.

FIG. 1B is a diagram illustrating an exemplary computer system with software and/or hardware modules that may execute some of the functionality described herein.

FIG. 1C is a diagram illustrating an exemplary computer system with software and/or hardware modules that may execute some of the functionality described herein.

FIG. 2 is a flow chart illustrating an exemplary method that may be performed in some embodiments.

FIG. 3 is a flow chart illustrating an exemplary method that may be performed in some embodiments.

FIG. 4 is a flow chart illustrating an exemplary method that may be performed in some embodiments.

FIG. 5 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In some embodiments, a system and computer-implemented methods are described for processing GPU instructions by a remote GPU server and sent from distributed client devices. A managing service operating on a managing server receives from a plurality of client devices requests to use one or more GPUs. In some embodiments, the request identifies a specific make and model of a GPU for performing GPU operations. While the following is described with reference to GPUs, the following system may also be used with regard to a tensor processing unit (TPU).

In some embodiments, the manager service determines whether any GPU servers have an available GPU that meets the requirements of the request to use one or more GPUs. The manager service obtains an IP address for an available GPU server that physically has the specified make and model of the specified GPU installed on the server. In some embodiments, the manager service provides a public key of the manager service to the requesting client device. The requesting client device signs data (e.g., messages and the sent GPU instructions with the public key). Data is encrypted by the managing server, a GPU server and the client device.

In some embodiments, the manager service identifies an available GPU on a GPU server and transmits an IP address and port of the available GPU to the requesting client device. The manager service creates a record of an identifier for the client device (such as identifier JSON web token, unique ID, etc.) and stores in a memory storage an association using the identifier of the client device with the assigned GPU server. In some embodiments, the manager service periodically monitors whether the client device is continuing to use the assigned GPU.

The assigned GPU server receives, over a network, messages including Accelerator API functions (also referred to as GPU instructions) to be performed by the GPU server. The GPU instructions are generated by a customized Accelerator API (based on the NVIDIA CUDA™ API model and/or the AMD™ ROCm API model) locally operating on the client device. The GPU server passes the received message data to corresponding Accelerator API functions for the accelerator (e.g., CUDA) on the GPU server to perform the GPU instructions. The local accelerator on the GPU server performs the GPU instructions which may return an output and/or error codes. The GPU server transmits the output and/or error codes to the requesting client device.

In some modes of operations, the customized Accelerator API performs operations to reduce the number or amount of GPU instructions that are transmitted by the client device to the remote GPU server. These operations perform functionality that reduces overall network latency inherently built-in to performing GPU instructions remotely by a GPU server.

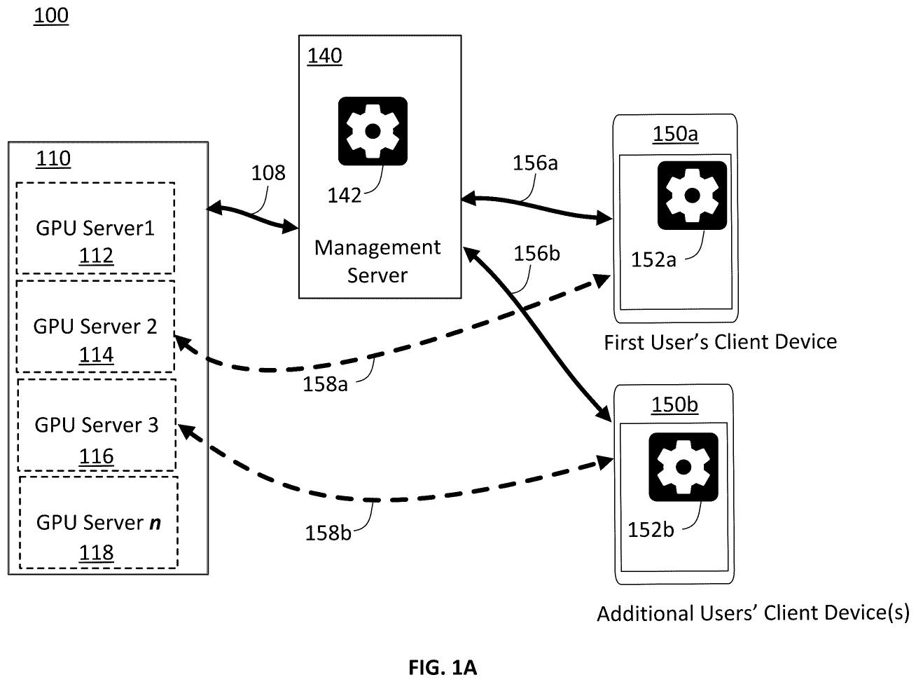

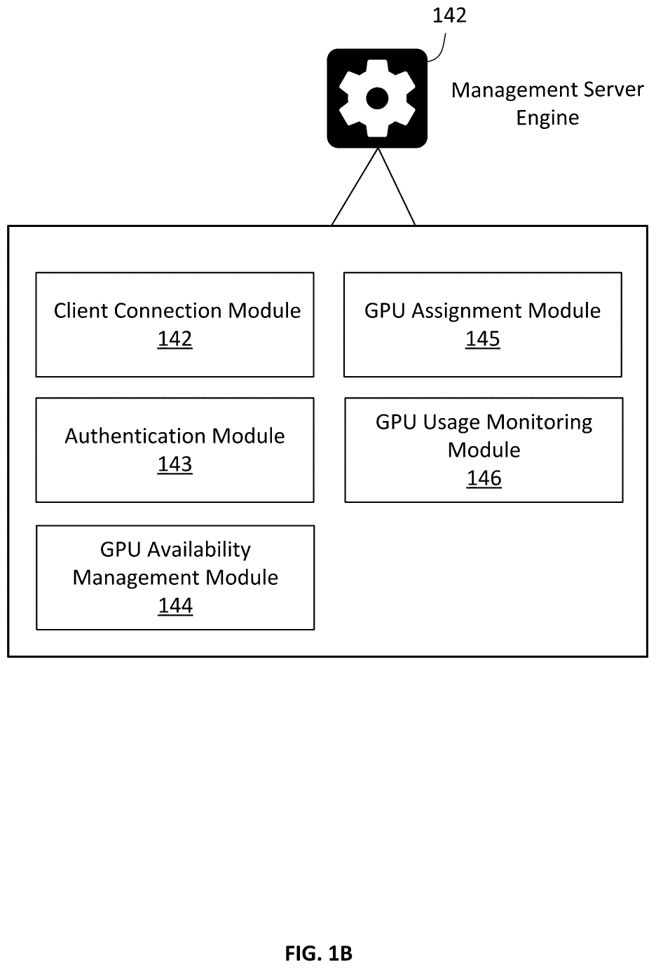

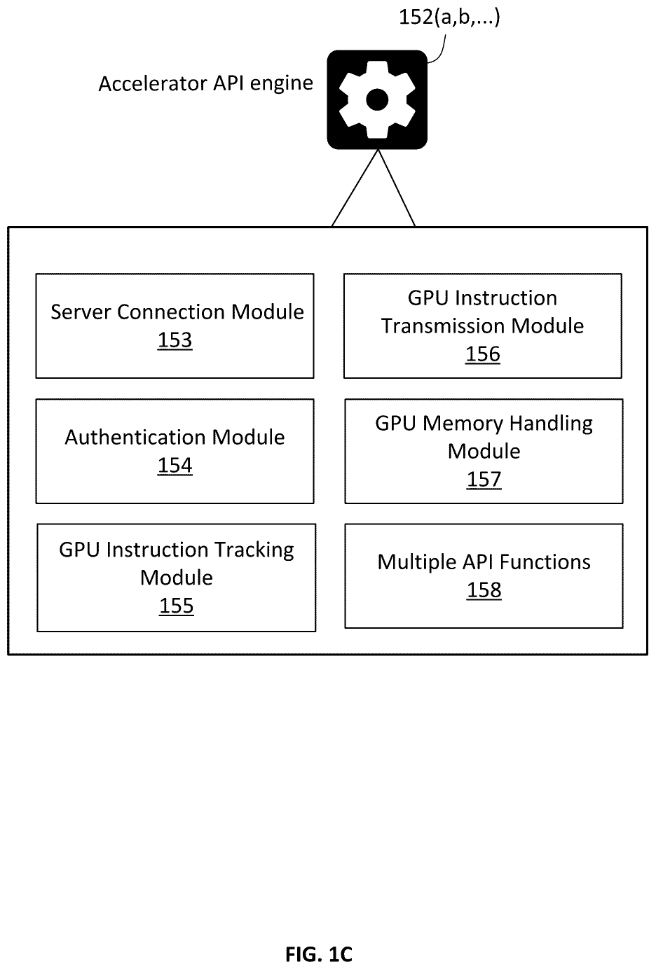

FIG. 1A is a diagram illustrating an exemplary environment in which some embodiments may operate. In the exemplary environment 100, a first user's client device 150a and one or more additional users'client device(s) 150b have installed on the client device a customized Accelerator API engine 152 (a, b, . . . ). The client devices 150a, 150b may communicate, via a network connection 156a, 156b (such as an Internet connection) with one or more Management Servers 140 running a code or a service (e.g., Management Server Engine 142) for interaction with the customized Accelerator API engine 152 (a, b, . . . ). The Management Server Engine 140 communicates over a network 108 (e.g., a local Ethernet network connection) to multiple GPU Servers 112, 114, 116, 118 of a GPU Server Farm 110. Each of the GPU Servers 112, 114, 116, 118 may have one or more GPUs of different makes and/or models installed on a respective GPU Server. The Management Server 142 assigns a GPU Server 112, 114, 116, 118 for access and use by a respective client device. Once the GPU Server is assigned, the client device may establish a peer-to-peer connection over a network connection 158a, 158b (such as an Internet connection) with the assigned GPU Server.

In some embodiments, the first user's client device 150a and additional users' client device(s) 150b are computing devices capable of hosting and executing one or more applications or other programs capable of sending and/or receiving information. In some embodiments, the first user's client device 150a and/or additional users' client device(s) 150b may be a computer desktop or laptop, mobile phone, video phone, conferencing system, or any other suitable computing device capable of sending and receiving information.

FIG. 1B is a diagram illustrating an exemplary Management Server Engine 142 with software and/or hardware modules that may execute some of the functionality described herein. The Management Server Engine 142 performs functionality to communicate with one or more client devices (150a, 150b, . . . ) and one or more GPU Servers (112, 114, 116, 118). The Management Server 142 receives a request from a client device to use a GPU based on a request received from a client device. The Management Server Engine 142 determines the availability of a GPU that can be used by the client device. The Management Server Engine 142 manages the client device connection and authentication processing with a client device. The Management Server Engine 142 also performs monitoring of assigned GPUs to determine if a client device is continuing to use an assigned GPU.

The Client Connection Module 143 provides functionality allowing a client device, via the Accelerator API Engine, to connect to the Management Server 140 and request one or more GPUs to be used for remote GPU instruction processing.

The Authentication Module 143 provides functionality to generate credentials and authentication information by the Management Server 140 so that the client device, via the Accelerator API Engine, can connect to and interact directly with an assigned GPU server (e.g. any one of 112-118).

The GPU Availability Management Module 144 provides functionality to determine which of the GPUs of the GPU Servers (112, 114, 116, 118) are available to be used by a client device. This module tracks which of the GPUs have been assigned for use to a client device.

The GPU Assignment Module 145 provides functionality to assign or allocate an available GPU to a client device. This module obtains an IP address for one of GPU Servers where the GPU can be accessed by the client device.

The GPU Usage Monitoring Module 146 provides functionality for monitoring if a client is continuing to use an assigned GPU of a GPU Server. In other words, this module periodically checks to see if an assigned GPU is still being used by a client device. If the module determines that the assigned GPU is not being used (such as the GPU has not received instructions for a predetermined period of time), then this module reallocates the GPU to a pool of available GPUs. Furthermore, the Client Connection Module 142 may revoke any credentials provided by the client device such that the client device can no longer access the assigned GPU Server.

FIG. 1C is a diagram illustrating an exemplary Accelerator API Engine (152a, 152b, . . . ) with software and/or hardware modules that may execute some of the functionality described herein. The Accelerator API Engine resides on a file system of a client device (150a, 150b, . . . ) and the Accelerator API Engine may be in the form of an application programming interface, .dlls, a service, executable software, etc. In some embodiments, the Accelerator API Engine is a customized API based on functions of the NVIDIA CUDA™ API model and/or the AMD™ ROCm API model.

In general, the customized Accelerator API Engine handles the function calls by a separate application, software or service for GPU instruction processing. Instead of performing the GPU instructions on a location GPU of the client device, the customized Accelerator API Engine transmits, over a network, GPU instructions to a remote GPU server for the remote GPU server to perform the GPU instructions.

In some embodiments, the Accelerator API Engine has processing that it performs to address issues with network latency. In other words, the Accelerator API Engine performs optimization functions to avoid transmission of the GPU instructions over the network when possible.

In some embodiments, the Accelerator API Engine includes additional functions or modules in addition to the typical functions of the NVIDIA CUDA™ API model and/or the AMD™ ROCm API model. For example, the Accelerator API Engine may include a Server Connection Module 153, an Authentication Module 154, a GPU Instruction Tracking Module 155, a GPU Instruction Transmission Module 156, a GPU Memory Handling Module 157 and Multiple API Functions 158 that are copied functionality of the NVIDIA CUDA™ API model and/or the AMD™ ROCm API model.

The Server Connection Module 153 provides functionality allowing a client device, via the Accelerator API Engine, to connect to the Management Server 140 and request one or more GPUs to be used for remote GPU instruction processing.

The Authentication Module 154 provides functionality to obtain credentials and authentication information from the Management Server 140 so that the client device, via the Accelerator API Engine, can interact directly with an assigned GPU server (e.g. any one of 112-118).

The GPU Instruction Tracking Module 155 provides functionality to track GPU instructions that are received, via the Accelerator API Engine from an application, software and/or a service operating on the client device. The GPU Instruction Tracking Module 155, for example, may store or track the GPU instructions in CPU memory of the client device for fast caching and instruction lookup. The tracking of the received GPU instructions may be evaluated later by the Accelerator API Engine to determine if any optimization functionality may be performed to avoid having to send the GPU instructions over the network to the GPU Server.

The GPU Instruction Transmission Module 156 provides functionality to handle the transmission and management of the GPU instructions from a client device to an assigned GPU Server. The GPU instructions are typically sent by the Accelerator API Engine from the client device to the GPU server in an asynchronous mode such that the calling application, software and/or service does not have to wait for results to be returned from the Accelerator API Engine. When results are returned from the GPU Server, the GPU Instruction Transmission Module 156 handles the received results and provides the results back to the calling application, software or service.

The GPU Memory Handling Module 157 provides functionality to handle GPU memory management where copy, reads and writing are to be performed to a GPU memory. Since a local GPU of the client device is not used, the GPU Memory Handling Module performs management and tracking of GPU memory as to the remote GPU Server. In some embodiments, GPU memory from the remote servers and/or pointers or memory handles are tracked by the Accelerator API Engine. For example, data may be stored or copied into CPU memory as to the memory of the GPU server. Accelerator API functions that perform memory copy commands can access the stored data in CPU memory, rather than having to request the data from the GPU Server.

The Multiple API Functions 158 are functions that are copied or similar functionality of the NVIDIA CUDA™ API model and/or the AMD™ ROCm API model. The Accelerator API Engine acts as a framework to perform remote GPU functionality with one or more GPUs located on remote servers. The Multiple API Functions 158 of the Accelerator API engine can perform most or all of the functions of the NVIDIA CUDA™ API model and/or the AMD™ ROCm API model.

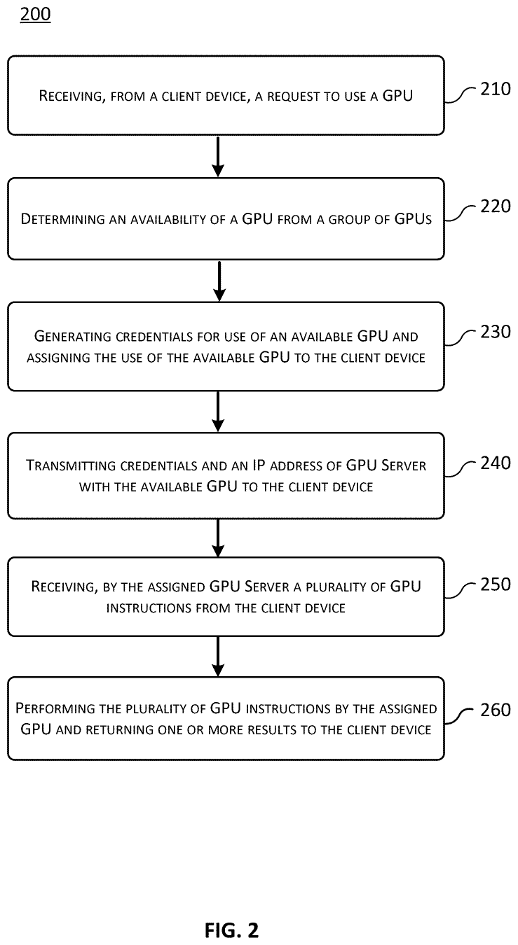

FIG. 2 is a flow chart illustrating an exemplary method 200 that may be performed in some embodiments. In step 210, the Management Server 140 receives a request from a client device 150a, 150b to use a GPU.

In step 220, the Management Server 140 determines whether there is an available GPU from a group of GPUs that meets the specifications, or the requirements as set for in the request. For example, the request may identify a particular make and model of a GPU that the client device would like to use.

In step 230, the Management Server 140 generates credentials for the use of an available GPU and assigns the use of the available GPU to the client device.

In step 240, the Management Server transmits credentials and an IP address of a GPU Server with the available GPU to the client device.

In step 250, the assigned GPU server receives from the client device, via the Accelerator API Engine 152 (a, b, . . . ) a plurality of GPU instructions for processing.

In step 260, a GPU operable on the assigned GPU Server performs the plurality of GPU instructions and returns one or more results to the client device to the Accelerator API Engine 152 (a, b, . . . ).

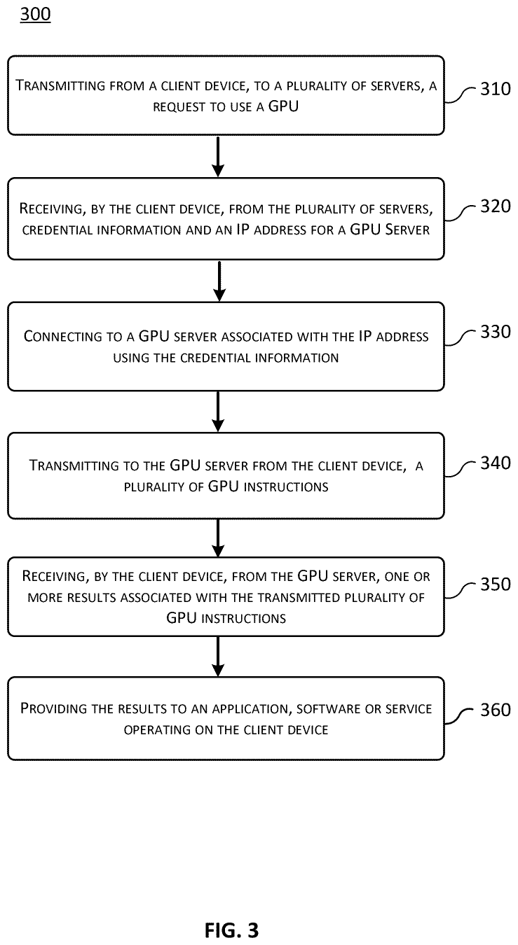

FIG. 3 is a flow chart illustrating an exemplary method 300 that may be performed in some embodiments.

In step 310, a client device transmits a request to the Management Server 140 to use a GPU. The request is sent via the Accelerator API Engine 152 (a, b, . . . ) to the Management Server 140.

In step 320, the client device receives from the Management Server 140 credential information and an IP address for the use of a GPU Server that has a GPU with the make and model as specified in the request.

In step 330, the client device connects to a GPU Server 112, 114, 116, 118 using the received IP address and the received credentials.

In step 340, the client device, via the Accelerator API Engine 152 (a, b, . . . ) transmits to the GPU Server a plurality of GPU instructions. The GPU instructions originate from function calls to Accelerator API Engine that are made by an application, software or service operating on the client device.

In step 350, the client device receives from the GPU Server one or more results associated with the transmitted plurality of GPU instructions.

In step 360, the Accelerator API Engine provides the received results to the application, software or service that made the function calls to the Accelerator API Engine.

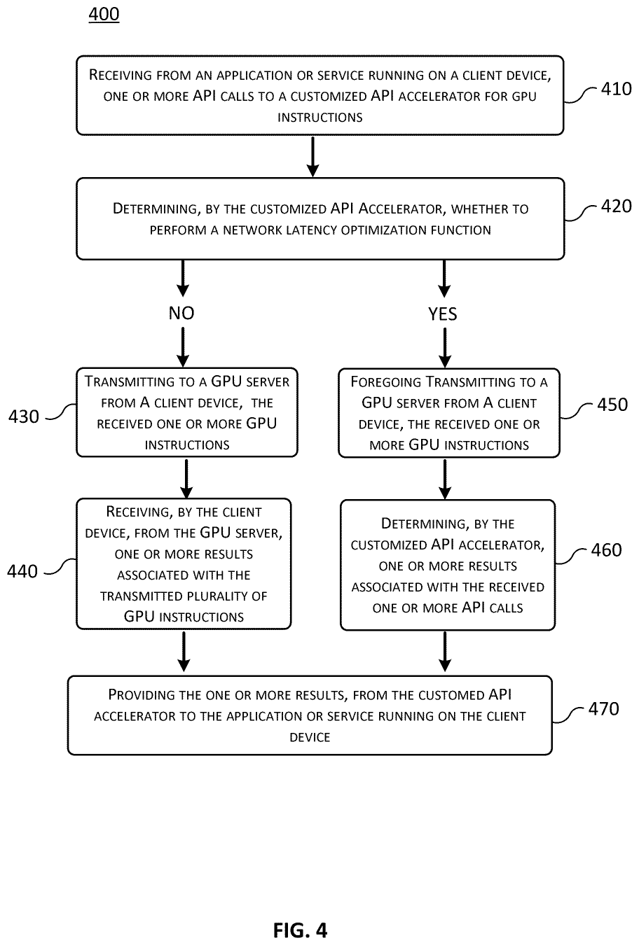

FIG. 4 is a flow chart illustrating an exemplary method 400 that may be performed in some embodiments.

In step 410, the customized Accelerator API 152a, 152b receives from an application, software or service being executed on a client device, one or more API function calls for GPU instructions to be performed.

In step 420, the customized Accelerator API determines whether to perform a network latency optimization function. If the customized Accelerator API determines to not perform a network latency optimization function, then steps 430 and 440 are performed. If the customized Accelerator API determines to perform a network latency optimization function, then steps 450 and 460 are performed.

In step 430, the customized Accelerator API transmits to a GPU server the received one or more GPU instructions. In step 440, the client device receives from the GPU server, one or more results and/or error codes associated with the transmitted plurality of GPU instructions.

In step 450, foregoing transmitting to a GPU server from the client device, the received one or more GPU instructions. In step 460, customized Accelerator API determines one or more results associated with the received one or more API calls.

### Network Latency Optimization Functions

The Accelerator API is configured to determine when and whether to perform functions to provide optimization of network latency. Generally, these network latency optimization functions reduce the number of transmissions that the Accelerator API makes to the GPU server. This optimization reduces the overall network latency associated with sending instructions over a network to be performed by a remote server or service. Some of these optimizations handle memory caching in CPU memory of GPU memory of the remote GPU server.

### Accelerator API Interactions Enabling Remote GPU Interaction

In some embodiments, the customized Accelerator API libraries (i.e. CUDA) are commonly dynamically linked. The customized Accelerator API 152 (a, b, . . . ) intercepts dynamic links to the accelerator API libraries using the LD_PRELOAD environment variable on Linux. The LD_PRELOAD loads the implementation of the customized Accelerator API before the actual implementation provided by the device manufacturer for the accelerator of the local GPU on the client device. This configuration causes the application, software or service to use the customized Accelerator API rather than an accelerator API to interact with the local GPU on the client device.

The client-side implementation of the customized Accelerator API redirects these function calls over a TCP network to the assigned remote GPU server. A corresponding GPU-side API running on the GPU server receives and processes these calls. This GPU-side API calls the actual accelerator API which interacts with the manufacturer's accelerator drivers and corresponding physical hardware of a locally installed GPU on the remote GPU server. This manufacturer accelerator API returns data to the GPU-side API which communicates and transmits data back to the client-side customized Accelerator API.

The application, software or service on the client device continues to use the client-side customized Accelerator API, behaving as if it is directly communicating with the manufacturer's accelerator API, but instead the functions are effectively being routed to the remote GPU server for processing, or that the customized Accelerator API is performing an optimization process where it determines that certain operations may be performed by the customized Accelerator API where GPU instructions are not needed to be sent to the remote GPU server.

The customized Accelerator API performs operations allowing the remote GPU on the remote GPU server to function correctly without direct communication with the client CPU and memory. In some embodiments, these operations occur when the client device's application, software or service calls a function of the customized Accelerator API that includes a pointer argument to a CPU memory space, where the customized Accelerator API needs to synchronize memory with the GPU server so that the remote GPU can use that required data. In these Accelerator API functions, the client application sends the CPU memory address and data to the customized Accelerator API, which is handled in that:
The GPU server receives this data and address and dynamically allocates corresponding memory on the CPU of the GPU server for this data with a different address.
The GPU server maps this GPU-side CPU memory address to the corresponding client-side CPU memory address. The memory contents are logically the same between the host and client CPU memory regions, however they correspond to different addresses, so the customized Accelerator API maintains a mapping between the addresses.
When returning the result from the GPU server back to the client device via the customized Accelerator API, the Accelerator API converts back to the client's device's memory address space using this mapping and returns the corresponding memory region.

An example of this operation is cudaMemcpy (CPU pointer, GPU pointer) or cudaGetDevice( ). Here the customized Accelerator API may use the GPU Server's CPU pointer for the stored CPU memory.

Accelerator API Optimization—Not blocking CPU program execution for API calls (functions) which write data to the accelerator. Typically, computer programs using accelerators are written with the assumption that connections between CPUs and accelerators have extremely low latency and high throughput. Modern software is written with this assumption, blocking CPU program execution for the duration of any write operations to an attached accelerator without meaningfully affecting performance. With a low-latency connection this blocking behavior does not significantly affect overall program execution speed. In higher-latency settings, this substantially increases overall program execution time.

The customized Accelerator API allows accelerator memory write operations to execute asynchronously which allows the CPU to continue program execution while the operation is in flight. Writing to an accelerator does not affect CPU/CPU-memory state, however returning data from the accelerator (reading from accelerator memory) does require blocking program execution, as the CPU program now depends on the new GPU memory state.

In some embodiments, the customized Accelerator API performs a GPU memory write operation from the CPU and continues executing other functions that do not rely on the new GPU state. When a function relies on this GPU state, the CPU program waits for all pending GPU operations to complete and performs a read operation from the updated GPU memory state. This functionality reduces the impact of a high-latency connection by allowing program execution to continue without waiting for slow data transfers when not necessary.

In some embodiments, the customized Accelerator API transmits one or more GPU instructions to the remote GPU and does not wait for a return value or a return output from the remote GPU server. The GPU server will perform the GPU instructions and the GPU server does not return a message to the client device that the GPU received or successfully executed the GPU instructions. For example, where the GPU instructions include a write function to the GPU memory, the customized Accelerator API may transmit the GPU instruction to the remote server and the control is returned to the calling application, software or service. The remote GPU server executes the write function and no return value or message is returned by the remote GPU server to the customized Accelerator API. However, if a status of the write function is needed, the calling application, software or service may use an explicit function check, such as CUDA get last error being made to the customized Accelerator API which then transmits the GPU instructions to the remote GPU server. The remote GPU server then would perform the CUDA get last error on the local accelerator of the local GPU on the remote GPU server. An error value is then obtained and transmitted from the remote GPU to the customized Accelerator API of the client device.

Accelerator API Optimization—Maintaining in-CPU-memory cache for functions with known results. Similarly, the assumption of low latency and high throughput connections between CPUs and accelerators allows frequent read/write operations in accelerator memory without noticeably affecting program execution speed. In a high-latency and low-throughput scenario, these frequent operations substantially reduce program execution speed. To reduce the number of API calls that require data transfer to/from the accelerator, the customized Accelerator API caches the results of functions with known results in CPU memory.

In some embodiments, the customized Accelerator API determines that a set of functions called by an application, software or service have predictable/repeatable results. When the set of these functions are called for the first time during a program, the function is normally run. The Accelerator API stores the results of the set of functions in the CPU memory cache. Later during the same program execution, if this function is called again, the Accelerator API first checks if the value is stored in the cache before calling the function normally. If a value is present in the cache, then the Accelerator API uses this instead of running the function (e.g., instead of sending the GPU instructions to the remote GPU server for processing). This caching dramatically reduces the total number of API calls, thus reducing program execution impact of expensive high-latency data transfers.

In some embodiments, the customized Accelerator API determines whether the value of a function can be cached in CPU memory. For example, where a GPU instruction includes a set command (e.g., where a value is set for a variable), then the customized Accelerator API creates in CPU memory the variable name and the value that is set. Similarly, other functions that perform a write to GPU memory may be cached to CPU memory.

Later when any call to the customized Accelerator API, that performs a GPU instruction of a get function (e.g., that reads a variable), the customized Accelerator API, will first read or evaluate CPU memory to find the particular variable that is to be read from the GPU memory. If the customized Accelerator API finds that variable in CPU memory, then the customized Accelerator API will return to the calling application, software or service, the value of the variable from CPU memory. The customized Accelerator API then does not transmit the GPU instruction to the remote GPU server.

Similarly, where a function the customized Accelerator API, may search the GPU memory first where data was previously written to the remote GPU. In these instances, the customized Accelerator API may store the data into CPU memory, where the customized Accelerator API first checks the CPU memory for the existence of the requested data.

In these cases, where the customized Accelerator API finds in the CPU memory, a stored value for a variable, prior data written to the remote GPU, preloaded values from the GPU (such as state data or values), etc., the customized Accelerator API does not need to transmit a GPU instruction over the network to the remote GPU. This process provides additional network latency optimization by reducing the number of transmissions made over the network to the remote GPU.

In some embodiments, the customized Accelerator API performed the functionality of not blocking CPU program execution for API calls (functions) which write data to the accelerator, and maintaining in-CPU-memory cache for functions with known results to obtain increased network latency optimization.

Accelerator API Optimization—Speculatively executing pure functions. In some embodiments, the Accelerator API speculatively executes functions in advance of an application, software or service calling the function. The customized Accelerator API caches return values and/or error codes in CPU memory for future access. This advanced function execution is particularly suited for functions without side effects to the GPU accelerator state (such as changing GPU memory) which would require a GPU instruction to be sent to the remote GPU server. Often accelerator workloads tend to be very predictable. Given a certain sequence of function calls, the customized Accelerator API frequently expects to receive the same function calls called next. In a high-latency environment, the time cost of each data transfer is frequently greater than the time cost of additional computation on the CPU of the client device. Thus, the customized Accelerator API determines a function may be called in a given situation, the time savings of potentially eliminating a network transfer is greater than the loss of the few times when the customized Accelerator API has to run the function unnecessarily (especially, in situations where the customized Accelerator API incorrectly determines a function will be called next).

As a result, when the customized Accelerator API identifies that certain functions are called, the customized Accelerator API can reduce total runtime by proactively (speculatively) running many of these pure functions and caching results in CPU memory. If these functions are called, the customized Accelerator API first checks to retrieve pre-calculated value(s) from the CPU memory cache. If the value(s) do not exist (in cases when a different function is called), then the customized Accelerator API runs the called function normally.

In some embodiments, only those functions that do not change the state of the GPU (e.g., write to the virtual memory) would be run since with this type of function, a GPU instruction would need to be sent to the GPU server to be performed on the remote GPU of the GPU server. An example of a function that could be run speculatively, would be one that would work would be read instructions. The customized Accelerator API could perform in advance a list of functions with their associated arguments and save the results in a memory cache on the local client device, such as the local client device memory. When the function is called again by the application, software or service, then the customized Accelerator API identifies that the function had been called previously. The customized Accelerator API could search for the results that were stored in memory for the function that was performed in advance, and provide the results function back to the calling application, software or service. These operations provide network latency optimization such that customized Accelerator API does not need to send the GPU instructions across a network to the assigned GPU Server.

In some embodiments, the customized Accelerator API performs a set of predetermined or predefined functions without these functions being called by the program, software or service executing on the client device. This set of predetermined or predefined functions may be performed by the customized Accelerator API, for example, when the customized Accelerator API first establishes a connection or use of the remote GPU server. In some embodiments, preloading of the CPU memory with properties of the remote GPU may be called as a group after connection to the remote GPU server.

Some examples of these predetermined or predefined functions may be a read or get type of operations which obtain a value from the remote GPU. The values from the remote GPU are received by the customized Accelerator API, which are then stored in CPU memory for later retrieval as described previously. For example, the customized Accelerator API obtains properties or values from the remote GPU and loads these values into CPU memory in the event that a calling program, software or service on the client device may request the values. Instead of having to transmit the GPU instructions across the network to the remote GPU server, these values are preloaded into CPU memory where the customized Accelerator API would retrieve the value from CPU memory and forgo the transmission of the GPU instruction to obtain the value. Examples of the functions are CUDA get device properties which obtains property values of the remote GPU.

In other embodiments, the customized Accelerator API may perform predefined functions to read or get attributes of an object that is dynamically created during the execution of an application, software or service on the local client device. For example, the customized Accelerator API may include predefined or predetermined read or get functions that obtain properties or attributes when data or an object (such as a matrix) is written to the remote GPU. Here the customized Accelerator API performs these additional read or get functions to obtain data values from the remote GPU. These data values associated with the created object then are stored in CPU memory for later retrieval without having to transmit a GPU instruction to the remote GPU server to obtain the data value.

In some embodiments, the customized Accelerator API will first search the CPU memory for data or a data value associated with a variable, read or get function. If the value does not exist in CPU memory, the customized Accelerator API will transmit a GPU instruction to the remote GPU server for that data or data value. After receiving the data or data value from the remote GPU server, the customized Accelerator API writes or stores to CPU memory on the local client device, the data or the data value with index information, such as a variable name, attribute name, property name, object name, etc. The customized Accelerator API would then retrieve the data from CPU, the next time a function is called to the customized Accelerator API by the application, software or service to retrieve the data or the data value from the remote GPU. The customized Accelerator API would then forgo transmitting the GPU instruction across the network to the remote GPU server.

In some embodiments, the customized Accelerator API maintains a history of the last set of function calls made to the customized Accelerator API. For example, the customized Accelerator API may keep track of a rolling history of the last 100 function calls made. The results of each function call received from the remote GPU server are stored in CPU memory in association with the function call. When the customized Accelerator API receives a subsequent function call (or a set of function calls such as 2 or more), the customized Accelerator API first searches the history to find if the function call or the set of function calls matches function call(s) in the history. If so, then the customized Accelerator API uses the results stored in memory and returns that data or values to the calling application, program or software. If not, then the customized Accelerator API sends the GPU instructions to the remote GPU server. These subsequent function call(s) are stored in the CPU memory, by the customized Accelerator API along with any results or data received from the remote GPU server.

Accelerator API Optimization—Maintaining in-CPU-memory cache of accelerator memory to reduce CPU-to-accelerator data transfers. Accessing data directly from CPU memory is extremely fast relative to overall program execution time, while reading from accelerator memory is relatively slow due to the transfer time between the accelerator and CPU. In some embodiments, to minimize the number of read operations that cross a high-latency connection over a network, the Accelerator API stores records of accelerator memory contents in CPU memory. To create these records, when the Accelerator API writes data to GPU memory via the remote GPU server, the Accelerator API also records the data in a local memory on the client device (such as a CPU memory cache). The Accelerator API maps the data in the local memory to the corresponding accelerator memory address of the GPU on the remote GPU server.

By storing a copy of the data in the local memory store, when a future function reads from any of these known addresses (as to the GPU memory), the Accelerator API can directly reference the CPU memory cache instead of crossing the high-latency connection to obtain the memory form the GPU on the remote GPU server. When specific write operations occur that modify the GPU memory on the remote GPU server (certain events like a kernel launch) these GPU memory values may change. In such cases, the Accelerator API may invalidate stored results which may have been overwritten.

In some embodiments, the Accelerator API prefetches data stored in memory on the local client device. For example, while the application, software or service (executing on the client device) is blocked and waiting for a response from the remote GPU server, the client, via the Accelerator API, sends CPU memory regions to the assigned remote GPU server that are likely to be used in future Accelerator API calls by the application, software or service. The remote GPU receives GPU instructions to write the received data to GPU memory. The remote GPU then may transmit a pointer, handle or other reference back to the client where the Accelerator API stores the GPU memory reference in a local memory store on the client device.

In some embodiments, the memory region of the CPU memory is selected by the Accelerator API based on the history of previous memory copies from the CPU to the GPU. When the prediction is correct, then the Accelerator API avoids an expensive network call when the data is being used on the remote GPU server.

In some embodiments, certain data may be preloaded to the remote GPU server for storage in GPU memory. For example, large data sets, pre-trained machine learning models, etc. may be transmitted to the remote GPU server where the remote GPU server stores and loads the received data into GPU memory. A reference to the location of the data in memory is returned from the GPU server where the Accelerator API uses the reference in later processing functions of the customized Accelerator API that are all called by a local application, software or service executing on the client device.

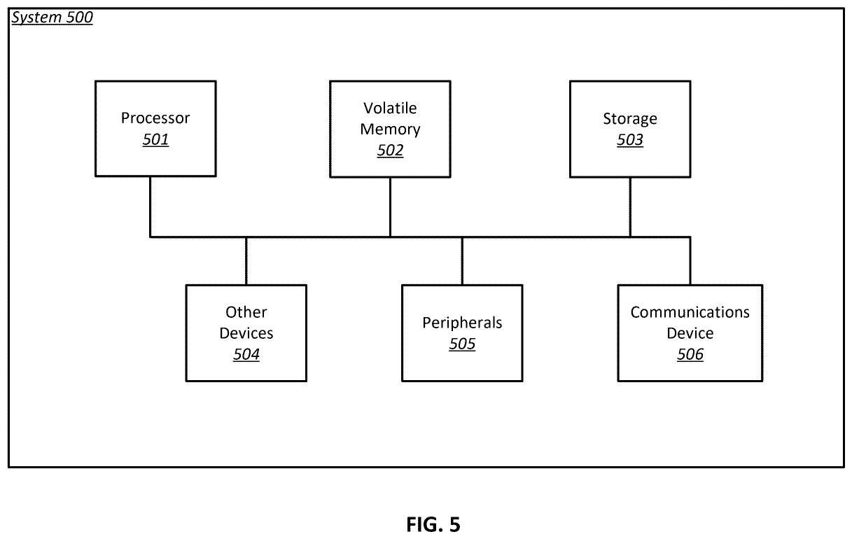

FIG. 5 is a diagram illustrating an exemplary computer that may perform processing in some embodiments. Exemplary computer 500 may perform operations consistent with some embodiments. The architecture of computer 500 is exemplary. Computers can be implemented in a variety of other ways. A wide variety of computers can be used in accordance with the embodiments herein.

Processor 501 may perform computing functions such as running computer programs. The volatile memory 502 may provide temporary storage of data for the processor 501. RAM is one kind of volatile memory. Volatile memory typically requires power to maintain its stored information. Storage 503 provides computer storage for data, instructions, and/or arbitrary information. Non-volatile memory, which can preserve data even when not powered and including disks and flash memory, is an example of storage. Storage 503 may be organized as a file system, database, or in other ways. Data, instructions, and information may be loaded from storage 503 into volatile memory 502 for processing by the processor 501.

The computer 500 may include peripherals 505. Peripherals 505 may include input peripherals such as a keyboard, mouse, trackball, video camera, microphone, and other input devices. Peripherals 505 may also include output devices such as a display. Communications device 506 may connect the computer 500 to an external medium. For example, communications device 506 may take the form of a network adapter that provides communications to a network. A computer 500 may also include a variety of other devices 504. The various components of the computer 500 may be connected by a connection medium such as a bus, crossbar, or network.

It will be appreciated that the present disclosure may include any one and up to all of the following examples.

Example 1. A system for processing GPU instructions from remote client devices, the system comprising one or more processors configured to perform the operations of: receiving, by a manager service, from a client device, a request to use one or more GPUs for performing GPU operations, the request being made from a customized Accelerator API executed on the client device; transmitting, from the plurality of servers, to the client device an IP address for access to a GPU server; receiving, via the Internet network, from the client device, a plurality of GPU instructions to be performed, via the GPU server on the specified GPU; performing by the GPU server the GPU instructions using local Accelerator API functions to perform the GPU instructions on a local GPU installed on the GPU server; receiving, by the GPU server, from the local GPU, output results and/or error codes based on the processing of the GPU instructions by the local GPU; and transmitting to the client device the output results and/or error codes to the client device.

Example 2. The system of Example 1, wherein the request identifies a specific make and model of a GPU for performing GPU operations: determining, by the manager service, whether any GPU server has an available GPU that meets the requirements of the request to use one or more GPUs.

Example 3. The system of any one of Examples 1-2, wherein the request identifies a specific make and model of a GPU for performing GPU operations: retrieving, by the manager service, the IP address for an available GPU server that physically has the specified make and model of the specified GPU installed on the server.

Example 4. The system of any one of Examples 1-3, wherein the client device locally calls one or more accelerator application programming interface (API) functions that are based on NVIDIA CUDA™ API model and/or the AMD™ ROCm API model.

Example 5. The system of any one of Examples 1-4, wherein the GPU instructions are asynchronously performing the plurality of the GPU instructions via the server GPU.

Example 6. The system of any one of Examples 1-5, wherein the GPU instructions include at least a GPU memory write operation, wherein instead of performing a local memory write operation on a GPU of the client device, the GPU memory write operation is performed via the plurality of servers and writing data into the allocated virtual memory.

Example 7. The system of any one of Examples 1-6, wherein the customized Accelerator API is configured to perform a network optimization function such that one or more GPU instructions are not sent the GPU server, but results for the GPU instructions are returned to an application, software or service that made calls the functions of the customized Accelerator API.

Example 8. The system of any one of Examples 1-7, wherein the customized Accelerator API is configured to perform a copying of data for a GPU memory to a CPU memory space, and the data in the CPU memory space is accessed in lieu of a GPU memory on the GPU server.

Example 9. A computer-implemented method for processing GPU instructions from remote client devices, the method comprising the operations of: receiving, by a manager service, from a client device, a request to use one or more GPUs for performing GPU operations, the request being made from a customized Accelerator API executed on the client device; transmitting, from the plurality of servers, to the client device an IP address for access to a GPU server; receiving, via the Internet network, from the client device, a plurality of GPU instructions to be performed, via the GPU server on the specified GPU; performing by the GPU server the GPU instructions using local Accelerator API functions to perform the GPU instructions on a local GPU installed on the GPU server; receiving, by the GPU server, from the local GPU, output results and/or error codes based on the processing of the GPU instructions by the local GPU; and transmitting to the client device the output results and/or error codes to the client device.

Example 10. The method of Example 9, wherein the request identifies a specific make and model of a GPU for performing GPU operations: determining, by the manager service, whether any GPU servers have an available GPU that meets the requirements of the request to use one or more GPUs.

Example 11. The method of any one of Example 9-10, wherein the request identifies a specific make and model of a GPU for performing GPU operations: retrieving, by the manager service, the IP address for an available GPU server that physically has the specified make and model of the specified GPU installed on the server.

Example 12. The method of any one of Example 9-11, wherein the client device locally calls one or more accelerator application programming interface (API) functions that are based on NVIDIA CUDA™ API model and/or the AMD™ ROCm API model.

Example 13. The method of any one of Example 9-12, wherein the GPU instructions are asynchronously performing the plurality of the GPU instructions via the server GPU.

Example 14. The method of any one of Example 9-13, wherein the GPU instructions include at least a GPU memory write operation, wherein instead of performing a local memory write operation on a GPU of the client device, the GPU memory write operation is performed via the plurality of servers and writing data into the allocated virtual memory.

Example 15. The method of any one of Example 9-14, wherein the customized Accelerator API is configured to perform a network optimization function such that one or more GPU instructions are not sent the GPU server, but results for the GPU instructions are returned to an application, software or service that made calls the functions of the customized Accelerator API.

Example 16. The method of any one of Example 9-14, wherein the customized Accelerator API is configured to perform a copying of data for a GPU memory to a CPU memory space, and the data in the CPU memory space is accessed in lieu of a GPU memory on the GPU server.

Example 17. Non-transitory computer storage medium that stores executable program instructions that when executed by at least one computing devices, configure the at least one computing devices to perform operations comprising: receiving, by a manager service, from a client device, a request to use one or more GPUs for performing GPU operations, the request being made from a customized Accelerator API executed on the client device; transmitting, from the plurality of servers, to the client device an IP address for access to a GPU server; receiving, via the Internet network, from the client device, a plurality of GPU instructions to be performed, via the GPU server on the specified GPU; performing by the GPU server the GPU instructions using local Accelerator API functions to perform the GPU instructions on a local GPU installed on the GPU server; receiving, by the GPU server, from the local GPU, output results and/or error codes based on the processing of the GPU instructions by the local GPU; and transmitting to the client device the output results and/or error codes to the client device.

Example 18. The non-transitory computer storage medium of Example 17, wherein the request identifies a specific make and model of a GPU for performing GPU operations:
determining, by the manager service, whether any GPU servers have an available GPU that meets the requirements of the request to use one or more GPUs.

Example 19. The non-transitory computer storage medium of any one of Examples 17-18, wherein the request identifies a specific make and model of a GPU for performing GPU operations: retrieving, by the manager service, the IP address for an available GPU server that physically has the specified make and model of the specified GPU installed on the server.

Example 20. The non-transitory computer storage medium of any one of Examples 17-19, wherein the client device locally calls one or more accelerator application programming interface (API) functions that are based on NVIDIA CUDA™ API model and/or the AMD™ ROCm API model.

Example 21. The non-transitory computer storage medium of any one of Examples 17-20, wherein the GPU instructions are asynchronously performing the plurality of the GPU instructions via the server GPU.

Example 22. The non-transitory computer storage medium of any one of Examples 17-21, wherein the GPU instructions include at least a GPU memory write operation, wherein instead of performing a local memory write operation on a GPU of the client device, the GPU memory write operation is performed via the plurality of servers and writing data into the allocated virtual memory.

Example 23. The non-transitory computer storage medium of any one of Examples 17-22, wherein the customized Accelerator API is configured to perform a network optimization function such that one or more GPU instructions are not sent the GPU server, but results for the GPU instructions are returned to an application, software or service that made calls the functions of the customized Accelerator API.

Example 24. The non-transitory computer storage medium of any one of Examples 17-23, wherein the customized Accelerator API is configured to perform a copying of data for a GPU memory to a CPU memory space, and the data in the CPU memory space is accessed in lieu of a GPU memory on the GPU server.

Some portions of the preceding detailed descriptions have been presented in terms of algorithms, equations and/or symbolic representations of operations on data bits within a computer memory. These algorithmic and/or equation descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system for processing graphical processing unit (GPU) instructions from remote client devices, the system comprising one or more processors configured to perform the operations of:
receiving, by a manager service, from a client device, a request to use one or more GPUs for performing GPU operations, the request being made from a customized Accelerator API executed on the client device;
transmitting, from a plurality of servers, to the client device an IP address for access to the GPU server;
receiving by the GPU server from the client device, data and a memory address of the data associated with a memory address space of a computer processing unit (CPU) of the client device;
dynamically allocating by the GPU server, corresponding data for the received data in a CPU memory of the GPU server;
mapping the received memory address with a memory address of the CPU of the GPU server for the dynamically allocated data;
receiving, via an Internet network, from the client device, a plurality of GPU instructions to be performed, via the GPU server on the specified GPU;
performing by the GPU server the GPU instructions using local Accelerator API functions to perform the GPU instructions on a local GPU installed on the GPU server;
receiving, by the GPU server, from the local GPU, output results and/or error codes based on the processing of the GPU instructions by the local GPU;
transmitting to the client device the output results and/or error codes to the client device.

2. The system of claim 1, wherein the request identifies a specified make and model of a GPU for performing GPU operations:
determining, by the manager service, whether any GPU servers has an available GPU that meets the requirements of the request to use one or more GPUs; and
assigning a GPU of the GPU server to the client device from a pool of available GPUS;
determining if an assigned GPU for a GPU server is still being used by the client device, and returning an assigned GPU to the pool of available GPUs when the assigned GPU is no longer being used by the client device.

3. The system of claim 2, wherein the request identifies a specified make and model of a GPU for performing GPU operations:
retrieving, by the manager service, the IP address for an available GPU server that physically has the specified make and model of the specified GPU installed on the server.

4. The system of claim 1, wherein the client device locally calls one or more accelerator application programming interface (API) functions that are based on NVIDIA CUDA™ API model and/or the AMD™ ROCm API model, and wherein the client device loads an implementation of the customized Accelerator API and the client device uses the customized Accelerator API rather than an accelerator of a device manufacturer of a local GPU on the client device.

5. The system of claim 1, wherein the GPU instructions include a memory write operation that is asynchronously performed via the server GPU, while the CPU of the client device continues to execute functions that do not rely on a GPU state of the GPU server.

6. The system of claim 1, wherein the GPU instructions include at least a GPU memory read operation, then performing a local memory read operation in the local memory of the client device, and
wherein the GPU instructions include at least a GPU memory write operation, wherein instead of performing a local memory write operation on a GPU of the client device, the GPU memory write operation is performed via the plurality of servers and writing data into an allocated virtual memory.

7. The system of claim 1, wherein the customized Accelerator API is configured to perform a network optimization function such that one or more GPU instructions are not sent the GPU server, but results for the GPU instructions are returned to an application, software or service that made calls the functions of the customized Accelerator API.

8. The system of claim 1, wherein the customized Accelerator API is configured to:
perform a copying of data from a memory space of the GPU server to a memory space of the client device;
mapping addresses of the data in the memory space on the client device with the data in the memory space on the GPU server;
wherein the data copied to the memory space of the client device is accessed in lieu of the data in the memory space on the GPU server when the GPU instructions include a function that reads from a mapped address of the memory space of the GPU server.

9. The system of claim 1, wherein the plurality of instructions comprise:
caching the results of the plurality of GPU instructions in a local memory store of the client device;
determining if the plurality of the GPU instructions are to be performed again; and
retrieving the results from the local memory store, and returning by the accelerator API the data of the stored results, instead of sending the GPU instructions from the client device to the server for processing the GPU instructions.

10. The system of claim 1, wherein the plurality of instructions comprise:
recording by the plurality of servers, the plurality of GPU instructions received from the client device;
determining, by the plurality of servers, whether based on identifying that a first set of instructions of the recorded plurality of GPU instructions are to be performed, then performing a second set of instructions of the recorded plurality of GPU instructions, where the second set of instructions occur serially after the first set of instructions.

11. A computer-implemented method for processing graphical processing unit (GPU) instructions from remote client devices, the method comprising the operations of:
receiving, by a manager service, from a client device, a request to use one or more GPUs for performing GPU operations, the request being made from a customized Accelerator API executed on the client device;
transmitting, from a plurality of servers, to the client device an IP address for access to the GPU server;
receiving by the GPU server from the client device, data and a memory address of the data associated with a memory address space of a computer processing unit (CPU) of the client device;
dynamically allocating by the GPU server, corresponding data for the received data in a CPU memory of the GPU server;
mapping the received memory address with a memory address of the CPU of the GPU server for the dynamically allocated data;
receiving, via an Internet network, from the client device, a plurality of GPU instructions to be performed, via the GPU server on the specified GPU;
performing by the GPU server the GPU instructions using local Accelerator API functions to perform the GPU instructions on a local GPU installed on the GPU server;
receiving, by the GPU server, from the local GPU, output results and/or error codes based on the processing of the GPU instructions by the local GPU;
transmitting to the client device the output results and/or error codes to the client device.

12. The method of claim 11, wherein the request identifies a specified make and model of a GPU for performing GPU operations:
determining, by the manager service, whether any GPU servers has an available GPU that meets the requirements of the request to use one or more GPUs; and
assigning a GPU of the GPU server to the client device from a pool of available GPUs;
determining if an assigned GPU for a GPU server is still being used by the client device, and returning an assigned GPU to the pool of available GPUs when the assigned GPU is no longer being used by the client device.

13. The method of claim 12, wherein the request identifies a specified make and model of a GPU for performing GPU operations:
retrieving, by the manager service, the IP address for an available GPU server that physically has the specified make and model of the specified GPU installed on the server.

14. The method of claim 11, wherein the client device locally calls one or more accelerator application programming interface (API) functions that are based on NVIDIA CUDA™ API model and/or the AMD™ ROCm API model, and wherein the client device loads an implementation of the customized Accelerator API and the client device uses the customized Accelerator API rather than an accelerator of a device manufacturer of a local GPU on the client device.

15. The method of claim 11, wherein the GPU instructions include a memory write operation that is asynchronously performed via the server GPU, while the CPU of the client device continues to execute functions that do not rely on a GPU state of the GPU server.

16. The method of claim 11, wherein the GPU instructions include at least a GPU memory write operation, wherein instead of performing a local memory write operation on a GPU of the client device, the GPU memory write operation is performed via the plurality of servers and writing data into an allocated virtual memory.

17. The method of claim 11, wherein the customized Accelerator API is configured to perform a network optimization function such that one or more GPU instructions are not sent to the GPU server, but results for the GPU instructions are returned to an application, software or service that made the function calls to the customized Accelerator API.

18. The method of claim 11, wherein the customized Accelerator API is configured to:
perform a copying of data from a memory space of the GPU server to a memory space of the client device;
mapping addresses of the data in the memory space on the client device with the data in the memory space on the GPU server;
wherein the data copied to the memory space of the client device is accessed in lieu of the GPU the data in the memory space on the GPU server when the GPU instructions include a function that reads from a mapped address of the memory space of the GPU server.

19. The method of claim 11, wherein the plurality of instructions comprise:
caching the results of the plurality of GPU instructions in a local memory store of the client device;
determining if the plurality of the GPU instructions are to be performed again; and
retrieving the results from the local memory store, and returning by the accelerator API the data of the stored results, instead of sending the GPU instructions from the client device to the server for processing the GPU instructions.

20. The method of claim 11, wherein the plurality of instructions comprise:
recording by the plurality of servers, the plurality of GPU instructions received from the client device;
determining, by the plurality of servers, whether based on identifying that a first set of instructions of the recorded plurality of GPU instructions are to be performed, then performing a second set of instructions of the recorded plurality of GPU instructions, where the second set of instructions occur serially after the first set of instructions.
